(19) United States
(12) Patent Application Publication
(10) Pub. No.: US 2010/0163468 A1
(43) Pub. Date: Jul. 1, 2010

(54) WATER TREATMENT APPARATUS

(75) Inventors: Eiichi Suzuki, Chiryu-shi (JP); Yukio Doi, Nishikamo-gun (JP); Jun Hibino, Chikusei-shi (JP); Hiroshi Yamashita, Chikusei-shi (JP)

Correspondence Address: OLIFF & BERRIDGE, PLC, P.O. BOX 320850, ALEXANDRIA, VA, 22320-4850, US

(73) Assignee: Fuji Clean Co., Ltd., Nagoya-shi (JP)

(21) Appl. No.: 12/452,349

(22) PCT Filed: Jun. 27, 2008
(86) PCT No.: PCT/JP2008/061772

§ 371 Date: Mar. 5, 2010

(30) Foreign Application Priority Data
Jun. 29, 2007 (JP) 2007-172220

(51) Int. Cl. B01D 35/00

(52) U.S. Cl. 210/91

(57) ABSTRACT

It is an object of the invention to provide a optimized rational water treatment technique for chemically treating water to be treated. A representative water treatment apparatus is adapted for chemically treating water by using chemicals. In a water treatment apparatus, a disinfectant within a chemical cartridge dissolves out in water to be treated in a disinfecting chamber so that the water is disinfected. Further, a magnet is disposed within the chemical cartridge. The accommodated position of the magnet within the chemical cartridge is changed according to the remaining amount of the disinfectants. The magnetism of such magnet is detected by a magnetic sensor disposed on the outside of the chemical cartridge, so that information on consumption of the disinfectant can be detected.

### FIELD OF THE INVENTION

The invention relates to a water treatment apparatus for treating water, and more particularly, to a technique for chemically treating water to be treated by dissolution of chemicals in the water to be treated.

### BACKGROUND OF THE INVENTION

As a water treatment apparatus such as domestic or industrial wastewater, a structure for disinfecting water to be treated is known. In this structure, it is necessary to conduct a water quality control for optimizing the quality of the disinfected water in order to solve the problem of excess and deficiency of disinfectant treatment. For example, Japanese laid-open patent publication No. 4-235798 discloses a technique of detecting residual chlorine contained in disinfected water by using a residual chlorine sensor in a septic tank. According to the known art, while it can be checked whether water to be treated is properly disinfected, the cost of equipment is increased due to use of such an expensive sensor as a residual chlorine sensor. Therefore, in designing a water treatment apparatus of this type, it is desired to provide a technique for readily checking whether a certain chemical treatment is properly performed.

### SUMMARY OF THE INVENTION

Accordingly, it is an object of the invention to provide a optimized rational water treatment technique for chemically treating water to be treated.

Above-described object is achieved by the claimed invention. A representative water treatment apparatus according to the invention includes at least a treatment tank body, a chemical treatment region, a flow passage, a chemical accommodation housing, a magnet and a magnetic sensor. The representative embodiment according to the invention may preferably be applied to a water treatment apparatus for purifying domestic wastewater, industrial wastewater or other similar water to be treated. The treatment tank body is tank-shaped. The chemical treatment region is adapted to be a region for chemical treatment of the water to be treated. The chemical accommodation housing is disposed on the flow passage through which the water flows in the chemical treatment region and accommodates chemicals which dissolve out in the water flowing through the flow passage. With regard to this construction, the flow passage can form the chemical treatment region in its entirety or in part. Further, with regard to this construction, the chemical accommodation housing typically has a vertically extending cylindrical shape. Each of the chemicals is typically a solid chemical contained in a predetermined container and dissolves out by flow of the water to be treated. The chemical can also be designed as a component element of the water treatment apparatus. The chemical dissolves out in the water flowing through the flow passage so that the water is chemically treated. The magnet is accommodated within the chemical accommodation housing and its accommodated position varies according to consumption of the chemicals within the chemical accommodation housing. In this case, it is only necessary for the accommodated position of the magnet within the chemical accommodation housing to change according to consumption of the chemicals. Therefore, it may be constructed such that the accommodated position of the magnet may change by the amount substantially corresponding to the height of the chemicals consumed in the vertically extending direction of the chemical accommodation housing, or it may also be constructed such that it changes independently of the height of the chemicals consumed. The magnetic sensor is mounted on a periphery of the chemical accommodation housing and detects magnetism of the magnet. The magnetic sensor may be designed as a switch that performs on-off action by the magnetism received from the magnet, or it may also be designed as a detecting element that detects the intensity of the magnetism received from the magnet. The chemical information output section has a function of outputting chemical information on consumption of the chemicals based on the magnetism that the magnetic sensor receives from the magnet. The chemical information output section is typically connected to the magnetic sensor by wired or wireless connection.

The “chemical information on consumption of the chemicals” here may include various information on consumption of the chemicals, such as the presence or absence and remaining amount of the chemicals, the amount and speed of consumption of the chemicals, information that the chemicals have run out or the chemicals are low, information as to whether the chemical treatment is properly performed or not, and also the time and amount of replenishment of the chemicals by consumption of the chemicals. Further, the output of the chemical information output section can be produced by appropriately using a display output method of displaying letters, figures or symbols on a display, a sound output method of outputting a voice or audible alarm to a speaker, a signal output method of outputting information detected by the magnetic sensor to a remote monitoring system which offers remote monitoring of a plurality of water treatment apparatus in a location remote from the water treatment apparatus, or other similar methods.

With this construction, the magnetism of the magnet of which accommodated position within the chemical accommodation housing changes according to the remaining amount of the chemicals is detected by the magnetic sensor disposed on the outside of the chemical accommodation housing, so that the user or caretaker of the water treatment apparatus can readily get information on consumption of the chemicals. Therefore, the chemical treatment can be optimized. Particularly, by provision of the construction in which the magnet without a connecting cable or the like is disposed within the chemical accommodation housing and the magnetic sensor with a connecting cable or the like is disposed on the outside of the chemical accommodation housing, the structure of the chemical accommodation housing can be made simpler. This construction is effective in avoiding a problem which occurs in the construction in which the magnetic sensor is disposed within the chemical accommodation housing, or particularly, occurrence of interference between the magnetic sensor and the chemicals.

Further, in a further embodiment of the water treatment apparatus according to the invention, preferably, the chemicals are formed by a plurality of solid chemicals which are vertically stacked one on another and accommodated within the chemical accommodation housing, and the chemicals are consumed by dissolving out starting from the lowermost solid chemical in the water flowing through the flow passage, and the magnet is laid on one of the solid chemicals which is located at a predetermined level. In this case, the solid chemical located at a predetermined level may be an uppermost one of the solid chemicals, or it may be a predetermined solid chemical disposed between the uppermost solid chemical and the lowermost chemical. Further, the magnetic sensor is preferably designed to detect the magnetism received from the magnet when the magnet comes close to the magnetic sensor. In this case, the solid chemical located at a predetermined level is designed as a supporting means for supporting the magnet from below. Further, preferably, the chemical information output section outputs the chemical information when the magnet lowers under its own weight and moves close to the magnetic sensor as the chemicals dissolve out. In this case, the amount of change of the accommodated position of the magnet substantially corresponds to the height of the chemicals consumed in the vertically extending direction of the chemical accommodation housing.

With this construction, the user or caretaker of the water treatment apparatus can get predetermined chemical information from the chemical information output section which outputs information according to the change of the accommodated position of the magnet laid on the solid chemical at the predetermined level. In this case, when the solid chemical at the predetermined level is the uppermost solid chemical, for example, the predetermined chemical information that the chemicals have run out is outputted. On the other hand, when the solid chemical at the predetermined level is a solid chemical disposed between the uppermost solid chemical and the lowermost chemical, the predetermined chemical information that the chemicals are low is outputted. By provision of this construction, a chemical remains unused above the magnet, so that time is given before the chemical completely run out.

Further, in a further embodiment of the water treatment apparatus according to the invention, preferably, the magnet is laid on the uppermost solid chemical. Further, the magnetic sensor is preferably mounted on the periphery of the chemical accommodation housing at a position corresponding to the position of the lowermost solid chemical. Further, the chemical information output section preferably outputs the chemical information that the chemicals have run out when the magnet lowers under its own weight and moves close to the magnetic sensor as the chemicals dissolve out. With this construction, the user or caretaker of the water treatment apparatus can get the chemical information that the chemicals have run out, from the chemical information output section which outputs information according to the change of the accommodated position of the magnet laid on the uppermost solid chemical.

Further, in a further embodiment of the water treatment apparatus according to the invention, preferably, the magnet has a double-sided bipolar structure with a north pole and a south pole vertically connected. Further, the magnetic sensor preferably includes a lead switch formed by two magnetic lead pieces which are made of a magnetic material and opposed to each other with a clearance. In such a construction, the magnet having a double-sided bipolar structure moves close to the lead switch in a direction that crosses the lead switch from above, so that the two magnetic lead pieces come into contact with each other in the clearance by the magnetism received from the magnet. With this construction, the operation range (typically the operation range in a direction transverse to the direction of movement of the magnet) in which the two magnetic lead pieces come into contact with each other in the clearance by the magnetism from the magnet, can be extended as much as possible. Therefore, such construction is effective in enhancing the accuracy of operation of the lead switch.

The water treatment apparatus in a further embodiment according to the invention preferably includes a first holder part for mounting the chemical accommodation housing to the treatment tank body and a second holder part for mounting the magnetic sensor on the periphery of the chemical accommodation housing, and the first and second holder parts are formed in one piece. This construction is rational in that a single holder having the integrally formed first and second holder parts has both the function of mounting the chemical accommodation housing to the treatment tank body and the function of mounting the magnetic sensor on the periphery of the chemical accommodation housing.

The water treatment apparatus in a further embodiment according to the invention preferably includes a first holder part for mounting the chemical accommodation housing to the treatment tank body and a second holder part for mounting the magnetic sensor on the periphery of the chemical accommodation housing, and the second holder part in which the magnetic sensor is mounted is allowed to move vertically with respect to the first holder part. As for the structure for mounting the second holder part, various structures can be used which have multiple settings of the vertical position of the second holder part with respect to the first holder part and can fix the second holder part to the first holder part at a desired set position.

With this construction, the amount of the chemicals remaining at the time when the magnetic sensor detects the magnetism of the magnet can be set. Generally, the speed of consumption of the chemicals varies from site to site by the amount of water, nitrogen concentration or other factors. With this construction, proper time of maintenance can be known by fixing the second holder part or the magnetic sensor at a position optimum for the site with respect to the first holder part, so that the maintenance can be facilitated.

Further, in a further embodiment of the water treatment apparatus according to the invention, preferably, the chemical accommodation housing has first and second housing openings which provide communication between the inside and the outside of the housing, and the first holder part is fitted on the periphery of the chemical accommodation housing and has first and second holder openings which are aligned with the first and second housing openings in the fitted state on the chemical accommodation housing. In such a construction, both the holder openings and the housing openings are formed on the flow passage. Therefore, the water flowing through the flow passage flows into the chemical accommodation housing through the first holder opening and the first housing opening and comes into contact with the chemicals, and thereafter, the water flows out of the chemical accommodation housing through the second housing opening and the second holder opening. Typically, the first holder opening is designed to be larger than the first housing opening, and the second holder opening is designed to be larger than the second housing opening.

With this construction, the water which flows into the chemical accommodation housing and then flows out of the chemical accommodation housing can create a smooth flow which does not interfere with contact of the water with the chemicals. Particularly, a rational construction is provided in which the first holder part for mounting the chemical accommodation housing to the treatment tank body is provided with a function for creating a smooth flow of the water.

Further, in a further embodiment of the water treatment apparatus according to the invention, preferably, the chemical accommodation housing has a vertically extending cylindrical shape and has a lid that closes a top of the housing, and the water treatment apparatus further includes an elongate connecting means that connects the lid and the magnet. The connecting means allows the magnet to move vertically within the chemical accommodation housing with the lid fitted over the housing top and has an extending length long enough to allow the magnet to be lifted up as the housing top is opened by upward opening movement of the lid. Typically, the connecting means is formed of a cord- or cable-like flexible material and has a linear extending length that substantially corresponds to the distance from the underside of the lid fitted over the housing top of the chemical accommodation housing to the lowermost position of the magnet within the chemical accommodation housing or to a position lower than the lowermost position.

With this construction, in use, the connecting means does not interfere with the movement of the magnet. Further, when the lid is opened in order to replenish the chemicals, the magnet is lifted up via the connecting means at the same time, so that the chemicals can be prevented from being accidentally replenished on the magnet. Thus, the chemicals can be reliably replenished under the magnet.

As described above, according to the invention, in a water treatment apparatus in which water to be treated is chemically treated by using chemicals, particularly by provision of the construction in which the magnet is disposed within a chemical accommodation housing together with the chemicals and changes in the accommodated position within the chemical accommodation housing according to the remaining amount of the chemicals and in which the magnetism of the magnet is detected by the magnetic sensor disposed on the outside of the chemical accommodation housing, information on consumption of the chemicals can be readily detected, so that the chemical treatment can be optimized.

### BRIEF DESCRIPTION OF THE DRAWINGS

FIG. 1 schematically shows a water treatment apparatus 100 according to an embodiment of a “water treatment apparatus” of the invention.

FIG. 2 shows the sectional structure of a chemical cartridge 121 in a disinfecting chamber 120 shown in FIG. 1, in the state in which disinfectants are not yet used.

FIG. 3 shows the sectional structure of the chemical cartridge 121 in the disinfecting chamber 120 shown in FIG. 1, during use of the disinfectants.

FIG. 4 is a perspective view showing the chemical cartridge 121 and a holder 125 in this embodiment in a disassembled state.

FIG. 5 is a perspective view showing the chemical cartridge 121 and the holder 125 in this embodiment in an assembled state.

FIG. 6 shows a magnet 124 and a magnetic sensor 140 in section in the state in which the magnet 124 is not activated.

FIG. 7 shows the magnet 124 and the magnetic sensor 140 in section in the state in which the magnet 124 is activated.

FIG. 8 shows a different embodiment as to the manner of accommodation of disinfectants 122 and the magnet 124 within the chemical cartridge 121.

FIG. 9 shows a different embodiment as to the manner of accommodation of the disinfectants 122 and the magnet 124 within the chemical cartridge 121.

FIG. 10 shows a holder 225 of a different embodiment.

FIG. 11 shows a lid 228 of a different embodiment.

### DETAILED REPRESENTATIVE EMBODIMENT OF THE INVENTION

A water treatment apparatus according to an embodiment of the invention is now described with reference to the drawings. This representative embodiment provides with a water treatment apparatus for treating domestic wastewater.

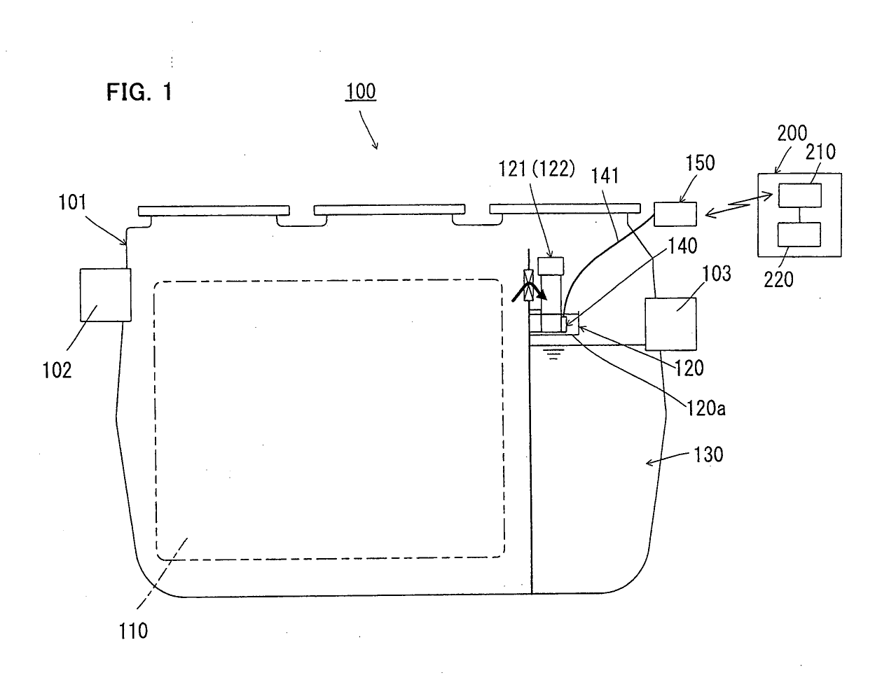

FIG. 1 schematically shows a water treatment apparatus 100 according to an embodiment of the invention. As shown in FIG. 1, the representative water treatment apparatus 100 has a tank-shaped treatment tank body 101 which houses a plurality of water treatment regions, i.e. an upstream treatment tank 110, a disinfecting chamber 120 and a storage tank 130. Wastewater flows into the treatment tank body 101 through an inlet part 102 and is treated in the upstream treatment tank 110, the disinfecting chamber 120 and the storage tank 130 in sequence. Thereafter, the treated water is discharged out of the treatment tank body 101 through an outlet part 103. In this case, the water treatment apparatus 100 may be configured as a septic tank which releases the water discharged out of the treatment tank body 101 as it is, or as a water reuse apparatus for reusing the water discharged out of the treatment tank body 101 as water for flushing toilets or watering. The treatment tank body 101 is a feature that corresponds to the “treatment tank body” according to the invention.

The upstream treatment tank 110 typically includes one or more of a foreign matter removal tank in which foreign matter contained within the water to be treated is separated from the water by using a solid-liquid separating device such as an inflow baffle (not shown), a foam separation tank in which foam is separated from the water, an anaerobic filter bed tank in which organic pollutant in the water is anaerobically treated (reduced), a contact aeration tank in which organic pollutant in the water is aerobically treated (oxidized), a precipitation tank in which suspended solids within the water is precipitated and removed, etc. Further, in this embodiment, the “water to be treated” or “water” includes wastewater to be treated in each tank and water that flows in the process of treating the wastewater.

The disinfecting chamber 120 has a function of supplying a disinfectant to the water that has been led from the upstream treatment tank 110. In the disinfecting chamber 120, a chemical cartridge 121 filled with a solid disinfectant 122 for disinfecting the water is disposed in a cartridge shelf 120a (also referred to as an overflow gutter). The disinfectant 122 dissolves out in the water as the water flows in. The chemical cartridge 121 is mounted to the treatment tank body 101 and a magnetic sensor 140 is mounted on the outside of the chemical cartridge 121, which will be described below in detail. The magnetic sensor 140 is activated by magnetism of a magnet 124 accommodated within the chemical cartridge 121, which will also be described below in detail. Further, the magnetic sensor 140 is connected to a transmitting section 150 by a cable 141. Thus, information from the magnetic sensor 140 is transmitted to the transmitting section 150, and then the information from the transmitting section 150 is transmitted to a receiving section 210 of a water quality control system 200 by radio and outputted at an output section 220. The water quality control system 200 is designed as a remote monitoring system which is placed remote from the water treatment apparatus 100 and it offers remote monitoring of information on the quality of water in a plurality of water treatment apparatus.

The water in which the disinfectant 122 has dissolved out in the disinfecting chamber 120 is disinfected in the disinfecting chamber 120 and then flows into the storage tank 130. In the storage tank 130, the water is temporarily stored before it flows out through the outlet section 103, and also in this stored state, the disinfectant treatment of the water is continued. Therefore, the storage tank 130 can also be referred to as a “disinfecting chamber” for disinfecting water to be treated, and the above-described disinfecting chamber 120 for supplying the disinfectant 122 to the storage tank 130 can also be referred to as a “chemical supply device” for the storage tank 130. The disinfecting chamber 120, or the disinfecting chamber 120 and the storage tank 130 on the downstream side of the disinfecting chamber 120 are treatment tanks for disinfectant treatment (chemical treatment) of water to be treated and form the “chemical treatment region in which the water to be treated is chemically treated”. The water that has flown out of the storage tank 130 is transferred to a toilet or a sprinkler system if the water treatment apparatus 100 is formed as a water reuse apparatus, while the water is released to a sewer as it is if the water treatment apparatus 100 is formed as a septic tank. In connection with this construction, an additional different tank, such as a release pump tank having a release pump, may be provided on the downstream side of the storage tank 130.

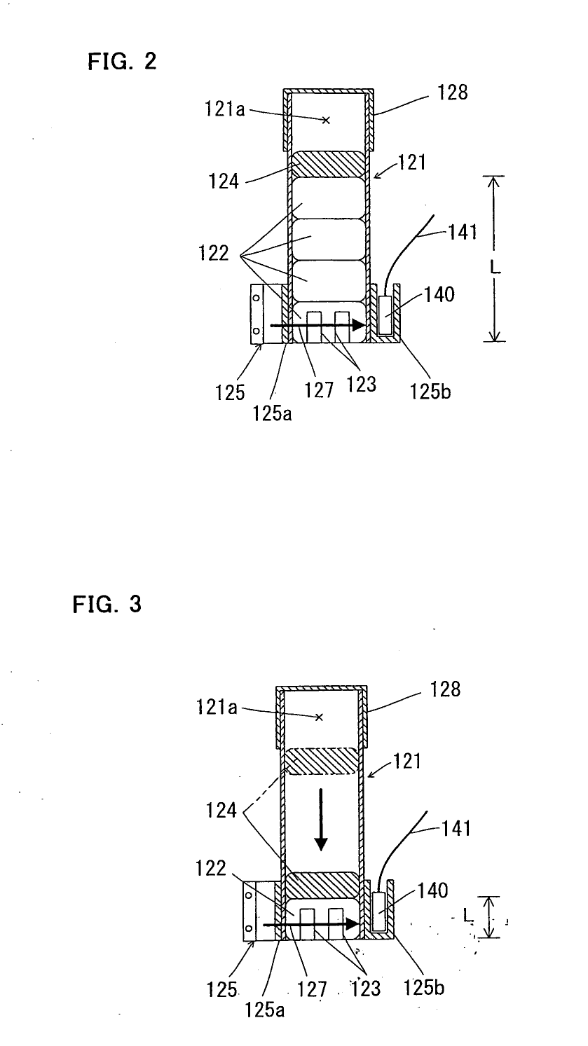

Specific construction and operation of the chemical cartridge 121 are now described with reference to FIGS. 2 and 3. FIG. 2 shows the sectional structure of the chemical cartridge 121 in the disinfecting chamber 120 shown in FIG. 1, in the state in which disinfectants are not yet used. FIG. 3 shows the sectional structure of the chemical cartridge 121 in the disinfecting chamber 120 shown in FIG. 1, during use of the disinfectants.

As shown in FIG. 2, the chemical cartridge 121 of this embodiment is formed as a chemical cartridge housing having a hollow accommodation space 121a. A plurality of (four in FIG. 2) disinfectants 122 are vertically stacked one on another and accommodated in the accommodation space 121a. Further, the chemical cartridge 121 has a lid 128 for closing a top of the vertically extending tubular housing. The lid 128 is fitted over the housing top in use, and opened for filling of the disinfectants 122 or for maintenance. Each of the disinfectants 122 is formed as a solid disinfectant, or typically a chlorinated solid disinfectant, having a diameter smaller than the bore diameter of the chemical cartridge 121. If such a chlorinated solid disinfectant is used, preferably, chlorine resistance of the chemical cartridge 121 may be ensured by providing a coating layer (such as a fluororesin coating) on an inner wall of the chemical cartridge 121 or by selecting a material of the chemical cartridge 121 itself. The chemical cartridge 121 is a feature that corresponds to the “chemical accommodation housing” according to the invention, and the disinfectant 122 is a feature that correspond to the “chemical” and the “solid chemical”. Further, a housing flow passage 123 through which the water led from the upstream treatment tank 110 into the disinfecting chamber 120 flows is formed in an area of the wall of the chemical cartridge 121 in which a lower region of the accommodation space 121a or a lowermost disinfectant 122 is located. The housing flow passage 123 is disposed on a flow passage 127 through which the water led from the upstream treatment tank 110 into the disinfecting chamber 120 flows. The flow passage 127 is a feature that corresponds to the “flow passage” according to the invention.

In this construction, the water to be treated flows through the flow passage 127 and the housing flow passage 123 of the chemical cartridge 121, and the disinfectants 122 successively dissolve out in the water starting from the lowermost disinfectant 122 and serves to disinfect (chlorinate) the water. Further, in this embodiment, the magnet 124 is laid on top of the uppermost disinfectant 122 in the accommodation space 121a. Specifically, the magnet 124 is supported from below by the uppermost disinfectant 122.

Further, the chemical cartridge 121 of this embodiment is mounted to the treatment tank body 101 via a holder (bracket) 125. The holder 125 has a first holding portion 125a and a second holding portion 125b. The first holding portion 125a serves to hold a lower portion of the chemical cartridge 121 from outside, and the second holding portion 125b serves to house and hold the magnetic sensor 140 on the outside (periphery) of the lower portion of the chemical cartridge 121. Specifically, in this embodiment, the first holding portion 125a for mounting the chemical cartridge 121 to the treatment tank body 101 and the second holding portion 125b for mounting the magnetic sensor 140 on the periphery of the chemical cartridge 121 are formed in one piece. With this construction, the chemical cartridge 121 is mounted to the treatment tank body 101, and at the same time, the magnetic sensor 140 is positioned with respect to the chemical cartridge 121. Thus, the single holder 125 having the integrally formed first and second holding portions 125a, 125b rationally has both the function of mounting the chemical cartridge 121 to the treatment tank body 101 and the function of mounting the magnetic sensor 140 on the periphery of the chemical cartridge 121. Further, in this embodiment, the area of housing and holding the magnetic sensor 140 is located in a position corresponding to the position of the lowermost chemical cartridge 121 in the accommodation space 121a. The first holding portion 125a or the holder 125 including the first holding portion 125a here forms the “first holder part” in the invention, and the second holding portion 125b here forms the “second holder part” according to the invention.

In connection with this construction, the second holding portion 125b may be dispensed with and the magnetic sensor 140 may be directly mounted on the periphery of the chemical cartridge 121. Alternatively, the second holding portion 125b may be provided on the bottom of the chemical cartridge 121 and the magnetic sensor 140 may be mounted to the second holding portion 125b, or the magnetic sensor 140 may be directly mounted on the bottom of the chemical cartridge 121 such that the magnetic sensor 140 is held in the bottom region of the chemical cartridge 121.

In the chemical cartridge 121 having the above-described construction, the disinfectants 122 are consumed by dissolving in the water to be treated, so that a vertical height L of the stack of the disinfectants 122 (in the vertical direction in FIG. 2) gradually decreases. Further, as shown in FIG. 3, as the vertical height L of the stack of the disinfectants 122 decreases (by consumption of the disinfectants), the magnet 124 lowers in position in the accommodation space 121a toward the magnetic sensor 140 under its own weight. Specifically, in this embodiment, the position of the magnet 124 accommodated in the chemical cartridge 121 changes according to the amount of the disinfectants 122 remaining in the chemical cartridge 121. In this case, the amount of change of the accommodated position of the magnet 124 substantially corresponds to the height of the disinfectants consumed in an extending direction of the chemical cartridge 121.

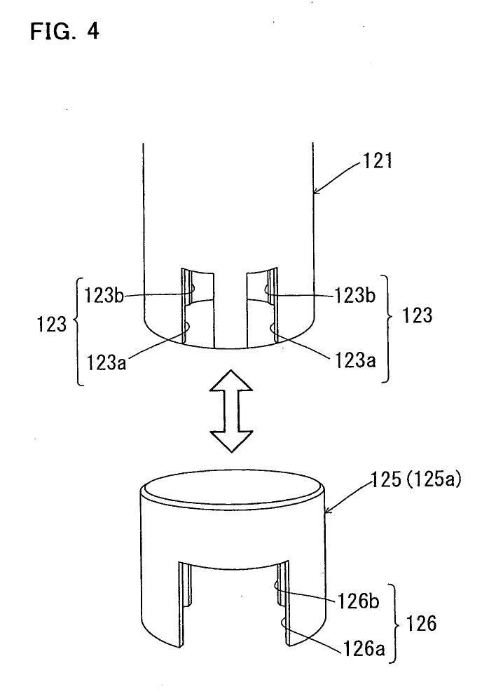

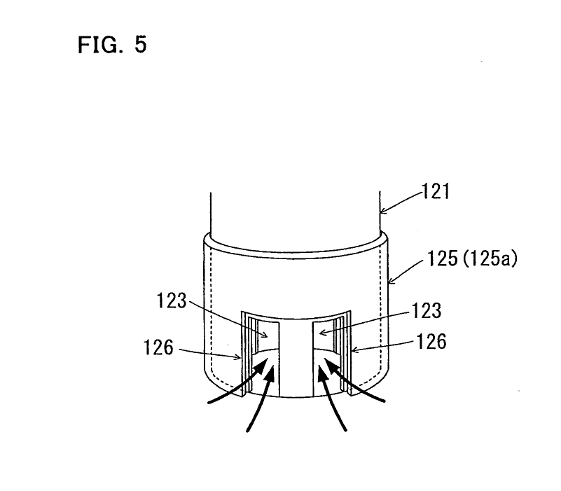

The specific construction of the chemical cartridge 121 and the holder 125 are further explained with reference to FIGS. 4 and 5. FIG. 4 is a perspective view showing the chemical cartridge 121 and the holder 125 in this embodiment in a disassembled state, and FIG. 5 is a perspective view showing the chemical cartridge 121 and the holder 125 in this embodiment in an assembled state.

As shown in FIGS. 4 and 5, in this embodiment, the housing flow passage 123 in the form of a notch or an opening is formed in the chemical cartridge 121, and a holder flow passage 126 in the form of a notch or an opening is formed in the holder 125. The housing flow passage 123 and the holder flow passage 126 are preferably aligned when the chemical cartridge 121 and the holder 125 are assembled. The housing flow passage 123 and the holder flow passage 126 are disposed on the flow passage 127 shown in FIG. 3 and form part of the flow passage 127.

The housing flow passage 123 provides communication between the inside and the outside of the housing of the chemical cartridge 121 and has at least a first housing opening 123a and a second housing opening 123b. The holder flow passage 126 provides communication between the inside and the outside of the holder 125 and has at least a first holder opening 126a and a second holder opening 126b. The holder 125 is fitted on the chemical cartridge 121, and in this state, the first and second holder openings 126a, 126b are aligned with the first and second housing openings 123a, 123b. Thus, the water flowing through the flow passage 127 shown in FIG. 3 flows into the chemical cartridge 121 through the first holder opening 126a and the first housing opening 123a and comes into contact with the disinfectants 122. Then, the disinfectants 122 dissolve out in the water and the water flows out of the chemical cartridge 121 through the second housing opening 123b and the second holder opening 126b.

Typically, the first holder opening 126a is designed to be larger than the first housing opening 123a, and the second holder opening 126b is designed to be larger than the second housing opening 123b. With this construction, the water which flows into the chemical cartridge 121 and then flows out of the chemical cartridge 121 can create a smooth flow which does not interfere with contact of the water with the disinfectants 122. Particularly, a rational construction is provided in which the holder 125 for mounting the chemical cartridge 121 to the treatment tank body 101 is provided with a function for creating a smooth flow of the water. The first housing opening 123a, the second housing opening 123b, the first holder opening 126a and the second holder opening 126b are features that correspond to the “first housing opening”, the “second housing opening”, the “first holder opening” and the “second holder opening”, respectively, according to the invention.

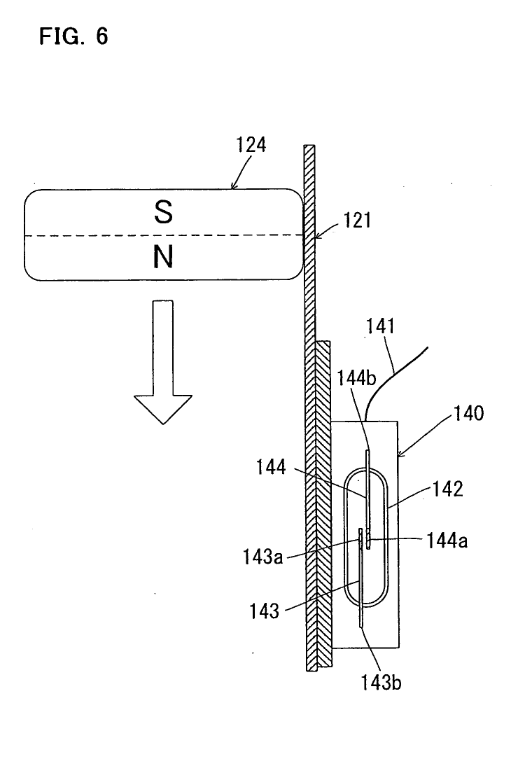

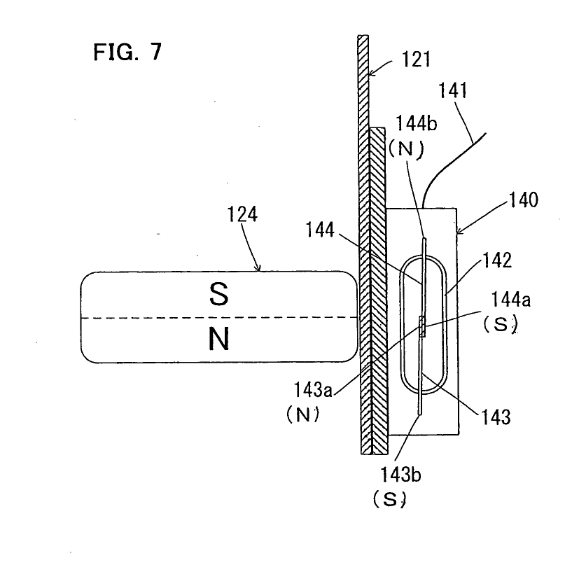

The specific construction and operation of the magnet 124 and the magnetic sensor 140 are now described with reference to FIGS. 6 and 7. FIG. 6 shows the magnet 124 and the magnetic sensor 140 in section in the state in which the magnet 124 is not activated. FIG. 7 shows the magnet 124 and the magnetic sensor 140 in section in the state in which the magnet 124 is activated.

As shown in FIG. 6, the magnet 124 of this embodiment is a permanent magnet having a so-called “double-sided bipolar structure” with a north pole and a south pole connected with each other in a vertical direction, and it typically has a cylindrical, tubular or annular (doughnut) shape. As the magnet 124, permanent magnets of various types, for example, having two poles on the right and left sides, two poles on one side, multipoles on the right and left sides, multipoles on one side, multipoles on the cylindrical inner circumferential surface, two poles on a columnar body, multipoles on a columnar body, multipoles on a cylindrical outer circumferential surface, (composite) multipoles on a disc, multipoles on a cylindrical body with skew, multipoles on a square body, multipoles on a circular body, or two poles on segments, can also be used as necessary. The magnet 124 is a feature that corresponds to the “magnet” according to the invention.

The magnetic sensor 140 of this embodiment is a so-called “lead switch” or “magnet switch” and has a function of detecting magnetism of the magnet 124 and accordingly performing on-off action. Specifically, as shown in FIG. 6, the magnet 124 has a glass tube 142a filled with inert gas and the two lead pieces 143, 144 sealed in the glass tube 142a. The magnetic sensor 140 is a feature that corresponds to the “magnetic sensor” according to the invention. The first lead piece 143 and the second lead piece 144 which form the magnetic sensor 140 are magnetic lead pieces made of a magnetic material and opposed to each other with a clearance between a contact of one end 143a of the first lead piece 143 and a contact of one end 144a of the second lead piece 144.

The magnetic sensor 140 having such a construction is not activated (in an off position in which the switch is off) when the magnetic sensor 140 is located in a region remote from the magnet 124 to which the magnetism (magnetic field) of the magnet 124 does not extend. In this state, the contact of the one end 143a of the first lead piece 143 and the contact of the one end 144a of the second lead piece 144 do not come into contact with each other (see FIG. 6). In this case, the transmitting section 150 transmits information indicating existence of the remaining disinfectants 122 to the receiving section 210 of the water quality control system 200 by radio, or does not transmit any information.

On the other hand, when the magnet 124 lowers toward the magnetic sensor 140 as explained with reference to FIG. 3, or the magnet 124 having a double-sided bipolar structure moves close to the magnetic sensor 140 in a direction that crosses the magnetic sensor 140 from above, and the magnetism that the magnetic sensor 140 receives from the magnet 124 reaches a predetermined value, the magnetic sensor 140 is activated (in an on position in which the switch is on). Specifically, by this movement of the magnet 124, the one end 143a of the first lead piece 143 bears a north pole and the other end 143b bears a south pole, while the one end 144a of the second lead piece 144 bears a south pole and the other end 144b bears a north pole. Therefore, the one end 143a (contact) of the first lead piece 143 and the one end 144a (contact) of the second lead piece 144 are attracted to each other by magnetic attraction and come into contact with each other in the above-described clearance (see FIG. 7). As a result, the magnetic sensor 140 is activated.

When the magnetic sensor 140 is activated, the transmitting section 150 which is connected to the magnetic sensor 140 via the cable 141 transmits information indicating that the amount of the disinfectants 122 remaining is zero or low, to the receiving section 210 of the water quality control system 200 by radio. Based on the information received by the receiving section 210, the output section 220 produces an output to encourage a user or a caretaker to conduct an inspection of the disinfecting chamber 120 or to replenish the disinfectants 122 in the disinfecting chamber 120. In this case, the output information of the output section 220 widely includes various information on consumption of the disinfectants 122, such as the presence or absence and remaining amount of the disinfectants 122, the amount and speed of consumption of the disinfectants 122, information that the disinfectants 122 have run out or the disinfectants 122 are low, information as to whether the disinfectant treatment is properly performed or not, and also the time and amount of replenishment of the disinfectants 122 by consumption of the disinfectants 122. Further, in this case, the output can be produced by appropriately using a display output method of displaying letters, figures or symbols on a display, a sound output method of outputting a voice or audible alarm to a speaker, or other similar methods. The output information here corresponds to the “chemical information on consumption of the chemicals” according to the invention. Further, the transmitting section 150, the receiving section 210 and the output section 220 serve to output chemical information on consumption of the disinfectants 122 based on the magnetism detected by the magnetic sensor 140, and form the “chemical information output section” according to the invention.

Further, according to the embodiment, alternatively or in addition to the above-described radio transmitting structure, an on-site output section (chemical information output section) may be provided in order to output the information that the amount of the disinfectants 122 remaining is zero or low when the magnetic sensor 140 is activated. With this construction, the user or caretaker of the water treatment apparatus 100 can get the information that the disinfectants 122 have run out or the disinfectants 122 are low, at the installation site of the water treatment apparatus 100.

Further, in this embodiment, preferably, the outside diameter of the magnet 124 is substantially equal to or slightly smaller than the outside diameter of the disinfectants 122. Moreover, preferably, an edge of the magnet 124 has a circular-arc rounded part, or the entire magnet 124 has a curved shape having a concave top. With such a construction, when the disinfectants 122 are consumed starting from the lowermost one and the magnet 124 correspondingly lowers, the magnet 124 can be prevented from getting stuck on the inner wall of the chemical cartridge 121. Thus, smooth lowering of the magnet 124 can be ensured, so that information on the remaining amount of the disinfectants 122 can be correctly detected by the magnetic sensor 140.

As described above, according to this embodiment, the magnetism of the magnet 124 of which accommodated position within the chemical cartridge 121 changes according to the remaining amount of the disinfectants 122 is detected by the magnetic sensor 140 disposed on the outside of the chemical cartridge 121, so that the user or caretaker of the water treatment apparatus 100 can readily get the information on consumption of the disinfectants 122. Therefore, the disinfectant treatment can be optimized. Particularly, by provision of the construction in which the magnet 124 without a connecting cable or the like is disposed within the chemical cartridge 121 and the magnetic sensor 140 with the cable 141 is disposed on the outside of the chemical cartridge 121, the internal structure of the chemical cartridge 121 can be made simpler. This construction is effective in avoiding a problem which occurs in the construction in which the magnetic sensor 140 is disposed within the chemical cartridge 121, or particularly, occurrence of interference between the magnetic sensor 140 and the disinfectants 122.

Further, according to the above-described embodiment, by provision of the construction in which the magnet 124 having a double-sided bipolar structure moves close to the magnetic sensor 140 (lead switch) in a direction that crosses the magnetic sensor 140 from above, so that the two magnetic lead pieces 143, 144 receive magnetism from the magnet 124 and come into contact with each other in the clearance, the operation range (typically the operation range in a direction transverse to the direction of vertical movement of the magnet 124) in which the two magnetic lead pieces 143, 144 come into contact with each other in the clearance by the magnetism from the magnet 124, can be extended as much as possible. Therefore, such construction is effective in enhancing the accuracy of operation of the lead switch.

Although, in the above-described embodiment, the single magnetic sensor 140 is described as being disposed on the outside of the chemical cartridge 121, a plurality of magnetic sensors 140 may be disposed in different positions in the vertical direction of the chemical cartridge 121. With this construction, the user or caretaker can get to know the remaining amount of the disinfectants 122 or the progress to exhaustion of the disinfectants 122 over time, so that management of the remaining amount of the disinfectants 122 to details can be performed.

### Other Embodiments

The invention is not limited to the above embodiment, but rather, may be added to, changed, replaced with alternatives or otherwise modified. For example, the following provisions can be made in application of this embodiment.

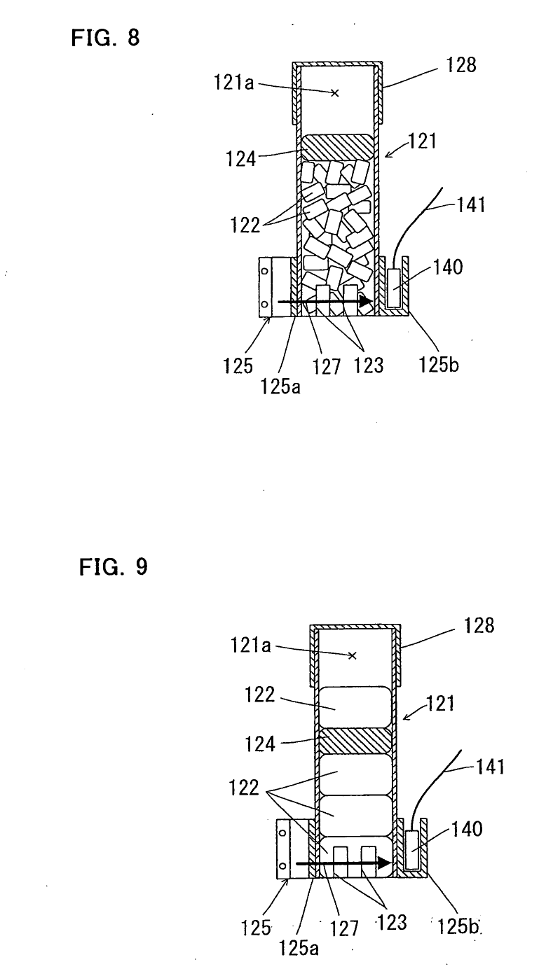

In the above-described embodiment, the disinfectants 122 are described as being vertically stacked within the accommodation space 121a of the chemical cartridge 121 and thereby regularly charged, but, in the invention, granular chemicals may irregularly charged. An example of this construction is shown in FIG. 8. In FIG. 8, a different embodiment is shown as to the manner of accommodation of the disinfectants 122 and the magnet 124 within the chemical cartridge 121. In the example shown in FIG. 8, the magnet 124 is laid on top of the irregularly charged granular disinfectants 122. In this example, the outside diameter of the magnet 124 is larger than that of the granular disinfectants 122.

Further, in the above-described embodiment, the magnet 124 is described as being laid on top of the uppermost disinfectant 122, but, in the invention, the magnet 124 may be disposed at a predetermined position between the disinfectants 122. An example of this construction is shown in FIG. 9. In FIG. 9, a different embodiment is shown as to the manner of accommodation of the disinfectants 122 and the magnet 124 within the chemical cartridge 121. In the example shown in FIG. 9, the magnet 124 is disposed on top of three of the four disinfectants 122 which are stacked three high, or between the third disinfectant 122 and the fourth disinfectant 122 from the bottom. With such a construction, at the time when the magnetic sensor 140 detects the magnetism of the magnet 124 after consumption of the lower three disinfectants 122, one disinfectant 122 remains unused above the magnet 124. Therefore, time is given before the disinfectant 122 completely runs out.

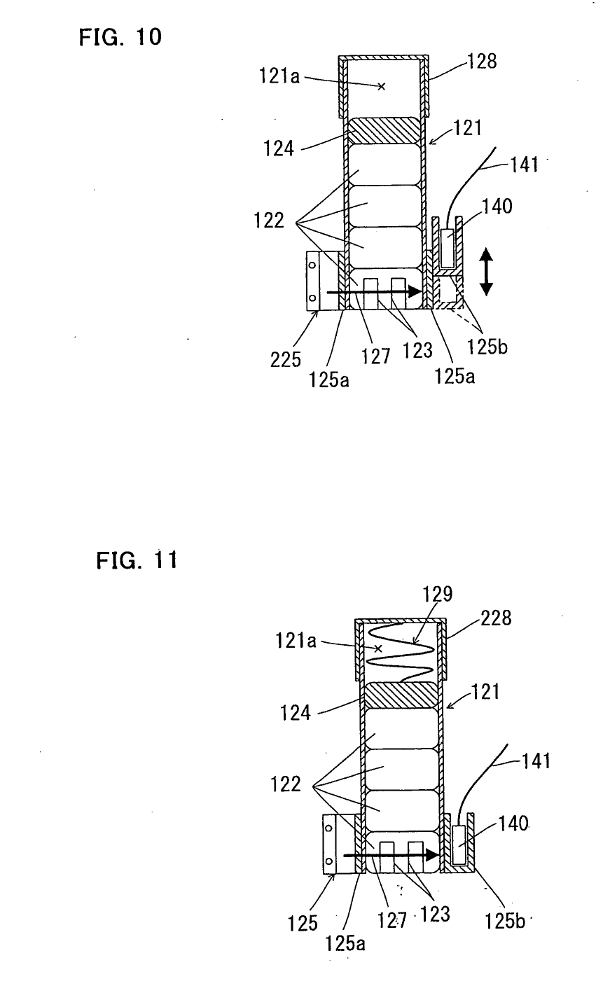

Further, in the above-described embodiment, the holder 125 is described as having the first holding portion 125a for mounting the chemical cartridge 121 to the treatment tank body 101 and the second holding portion 125b for mounting the magnetic sensor 140 on the periphery of the chemical cartridge 121 which are formed in one piece, but, in the invention, a holder having a different construction from the holder 125 may be used. An example of this construction is shown in FIG. 10. In FIG. 10, a holder 225 of a different embodiment is shown. In the holder 225, the second holding portion 125b for mounting the magnetic sensor 140 is mounted to the first holding portion 125a such that it is allowed to move in the vertical direction (the vertical direction in FIG. 10) with respect to the first holding portion 125a for mounting the chemical cartridge 121 to the treatment tank body 101. As for the structure for mounting the second holding portion 125b, various structures can be used which have multiple settings of the vertical position of the second holding portion 125b with respect to the first holding portion 125a and can fix the second holding portion 125b to the first holding portion 125a at a desired set position.

With such a construction, the amount of the disinfectants 122 remaining at the time when the magnetic sensor 140 detects the magnetism of the magnet 124 can be set. For example, if the second holding portion 125b is set in a position shown by phantom line in FIG. 10, at the time when the magnetic sensor 140 detects the magnetism of the magnet 124, any disinfectant 122 which can be used thereafter hardly remains. On the other hand, if the second holding portion 125b is set in a position shown by solid line in FIG. 10, at the time when the magnetic sensor 140 detects the magnetism of the magnet 124, one disinfectant 122 which has just begun to be consumed remains below the magnet 124, so that time is given before the disinfectant 122 completely runs out.

Generally, the speed of consumption of the disinfectants varies from site to site by the amount of water, nitrogen concentration or other factors. According to the embodiment as shown in FIG. 10, proper time of maintenance can be known by fixing the second holding portion 125b or the magnetic sensor 140 at a position optimum for the site with respect to the first holding portion 125a, so that the maintenance can be facilitated.

Further, the above-described embodiment is provided on the premise that the disinfectants 122 are placed under the magnet 124. However, when the disinfectants 122 are completely consumed and the magnet 124 is located at the bottom within the chemical cartridge 121, the disinfectants 122 may be replenished on top of the magnet 124, which may conceivably interfere with detection of certain information. Therefore, it is preferable to apply the construction shown in FIG. 11. In FIG. 11, a lid 228 of a different embodiment is shown. The lid 228 is connected to the magnet 124 via an elongate connecting means 129.

As shown in FIG. 11, the connecting means 129 allows the magnet 124 to move vertically within the chemical cartridge 121 with the lid 228 fitted over the housing top of the chemical cartridge 121 and has an extending length long enough to allow the magnet 124 to be lifted up as the housing top of the chemical cartridge 121 is opened by upward opening movement of the lid 228. Typically, the connecting means 129 is formed of a cord- or cable-like flexible material and has a linear extending length that substantially corresponds to the distance from the underside of the lid 228 fitted over the housing top of the chemical cartridge 121 to the lowermost position of the magnet within the chemical cartridge 121 or to a position lower than the lowermost position. The connecting means 129 and the lid 228 here are features that correspond to the “connecting means” and the “lid”, respectively, according to the invention.

With such a construction, in use, the connecting means 129 does not interfere with the movement of the magnet 124. Further, when the lid 228 is opened in order to replenish the disinfectants 122, the magnet 124 is lifted up via the connecting means 129 at the same time, so that the disinfectants 122 can be prevented from being accidentally replenished on the magnet 124. Thus, the disinfectants 122 can be reliably replenished under the magnet 124.

Further, in the above-described embodiment, the magnetic sensor 140 is designed as a switch that performs on-off action by the magnetism received from the magnet 124. In the invention, however, the magnetic sensor may be designed, like a Hall element magnetic sensor utilizing the Hall effect, such that it detects the intensity of the magnetism received from the magnet and such that the chemical information output section outputs information on consumption of the chemicals. Further, as the magnetic sensor other than the Hall element magnetic sensor, a magnetic sensor formed by a magnetoresistance (MR) element utilizing a magnetoresistance effect, or a flux-gate (magnetic modulation) magnetic sensor which uses a core having a so-called square-type B-H curve can be used.

Further, in the above-described embodiment, the position of the magnet 124 accommodated within the chemical cartridge 121 is described as changing by the amount substantially corresponding to the height of the disinfectants 122 consumed in the vertically extending direction of the chemical cartridge 121. In the invention, however, it is only necessary for the position of the magnet 124 accommodated within the chemical cartridge 121 to change with consumption of the disinfectants 122. Therefore, it can also be constructed such that the accommodated position of the magnet 124 changes independently of the height of the disinfectants 122 consumed.

Further, in the above-described embodiment, the magnet 124 is described as being disposed within the chemical cartridge 121 and changing in accommodated position with consumption of the disinfectants 122, and the magnetic sensor 140 for detecting the magnet 124 is described as being disposed outside the chemical cartridge 121, but other constructions can be applied as necessary. For example, a wireless magnetic sensor which changes in accommodated position with consumption of the disinfectants 122 may be disposed within the chemical cartridge 121, and a magnet which is detected by this wireless magnetic sensor may be disposed outside the chemical cartridge 121.

Further, in the above-described embodiment, the magnetic sensor 140 is described as being accommodated and held on the outside (periphery) of the chemical cartridge 121 by the second holding portion 125b. In the invention, however, the installation position of the magnetic sensor 140 is not limited to the periphery of the chemical cartridge 121, but can be differently changed as necessary. For example, it can also be disposed on the bottom of the chemical cartridge 121. Specifically, it is only necessary to be constructed such that the magnet 124 and the magnetic sensor 140 come close to each other as the disinfectants 124 are consumed and the magnetism of the magnet 124 is detected by the magnetic sensor 140.

Further, in the above-described embodiment, information on consumption of the disinfectants is outputted, but the invention can also be applied to a construction in which information on consumption of any chemical other than the disinfectants is outputted.

Further, in the above-described embodiment, a domestic wastewater treatment apparatus is described. However, the invention can also be applied likewise to various industrial wastewater treatment apparatus.

### DESCRIPTION OF NUMERALS

100 wastewater treatment apparatus
101 treatment tank body
102 inlet part
103 outlet part
110 upstream treatment tank
120 disinfecting chamber
120a cartridge shelf
121 chemical cartridge
121a accommodation space
122 disinfectant
123 housing flow passage
123a first housing opening
123b second housing part
124 magnet
125, 225 holder
125a first holding portion
125b second holding portion
126 holder flow passage
126a first holder opening
126b second holder opening
127 flow passage
128, 228 lid
129 connecting means
130 storage tank
140 magnetic sensor
141 cable
142 glass tube
143 first lead piece
144 second lead piece
143a, 144a one end
143b, 144b other end
150 transmitting section
200 water quality control system
210 receiving section
220 output section

1. A water treatment apparatus for treating water to be treated comprising:
a treatment tank body,
a chemical treatment region in which the water to be treated is chemically treated,
a flow passage through which the water flows in the chemical treatment region,
a chemical accommodation housing that is disposed on the flow passage and accommodates chemicals which dissolve out in the water flowing through the flow passage,
a magnet that is accommodated within the chemical accommodation housing and changes in accommodated position according to consumption of the chemicals within the chemical accommodation housing,
a magnetic sensor that is mounted on a periphery of the chemical accommodation housing and detects magnetism of the magnet, and
a chemical information output section that outputs chemical information on consumption of the chemicals based on the magnetism detected by the magnetic sensor.

2. The water treatment apparatus as defined in claim 1, wherein:
the chemicals are formed by a plurality of solid chemicals which are vertically stacked one on another and accommodated within the chemical accommodation housing, and the chemicals are consumed by dissolving out starting from the lowermost solid chemical in the water flowing through the flow passage, and the magnet is laid on one of the solid chemicals which is located at a predetermined level,
the magnetic sensor detects magnetism received from the magnet when the magnet comes close to the magnetic sensor, and
the chemical information output section outputs the chemical information when the magnet lowers under its own weight and moves close to the magnetic sensor as the chemicals dissolve out.

3. The water treatment apparatus as defined in claim 2, wherein:
the magnet is laid on the uppermost solid chemical,
the magnetic sensor is mounted on the periphery of the chemical accommodation housing at a position corresponding to the position of the lowermost solid chemical, and
the chemical information output section outputs the chemical information that the chemicals have run out when the magnet lowers under its own weight and moves close to the magnetic sensor as the chemicals dissolve out.

4. The water treatment apparatus as defined in claim 2, wherein:
the magnet has a double-sided bipolar structure having a north pole and a south pole which are vertically connected,
the magnetic sensor includes a lead switch formed by two magnetic lead pieces which are made of a magnetic material and opposed to each other with a clearance, and
the magnet having a double-sided bipolar structure moves close to the lead switch in a direction that crosses the lead switch from above, whereby the two magnetic lead pieces come into contact with each other in the clearance by the magnetism received from the magnet.

5. The water treatment apparatus as defined in claim 1, comprising:
a first holder part for mounting the chemical accommodation housing to the treatment tank body, and
a second holder part for mounting the magnetic sensor on the periphery of the chemical accommodation housing, wherein the first and second holder parts are formed in one piece.

6. The water treatment apparatus as defined in claim 1, comprising:
a first holder part for mounting the chemical accommodation housing to the treatment tank body, and
a second holder part for mounting the magnetic sensor on the periphery of the chemical accommodation housing, wherein the second holder part in which the magnetic sensor is mounted is vertically movable with respect to the first holder part.

7. The water treatment apparatus as defined in claim 5, wherein the chemical accommodation housing has first and second housing openings which provide communication between the inside and the outside of the housing, and the first holder part is fitted on the periphery of the chemical accommodation housing and has first and second holder openings which are aligned with the first and second housing openings in the fitted state on the chemical accommodation housing, whereby the water flowing through the flow passage flows into the chemical accommodation housing through the first holder opening and the first housing opening and comes in contact with the chemicals, and thereafter, the water flows out of the chemical accommodation housing through the second housing opening and the second holder opening.

8. The water treatment apparatus as defined in claim 1, wherein:
the chemical accommodation housing has a vertically extending cylindrical shape and has a lid that closes a top of the housing,
further comprising an elongate connecting means that connects the lid and the magnet, wherein the connecting means allows the magnet to move vertically within the chemical accommodation housing with the lid fitted over the housing top and has an extending length long enough to allow the magnet to be lifted up as the housing top is opened by upward opening movement of the lid.
